(19) United States
(12) Patent Application Publication
(10) Pub. No.: US 2024/0146548 A1
(43) Pub. Date: May 2, 2024

(54) KEY GENERATION USING ENTROPY HARVESTING FROM EMBEDDED SRAM ARRAYS

(71) Applicant: Meta Platforms Technologies, LLC, Menlo Park, CA (US)

(72) Inventors: Sudhir Satpathy, Redmond, WA (US); Renji George Thomas, Hillsboro, OR (US); Shrirang Madhav Yardi, San Jose, CA (US)

(21) Appl. No.: 17/933,892

(22) Filed: Sep. 21, 2022

Related U.S. Application Data
(60) Provisional application No. 63/369,598, filed on Jul. 27, 2022.

(51) Int. Cl. H04L 9/32; H04L 9/08; H04L 9/30

(52) U.S. Cl. CPC H04L 9/3278; H04L 9/0866; H04L 9/30

(57) ABSTRACT

A testing system includes one or more processors; and a memory storing instructions that, when executed, cause the one or more processors to: perform, on each array of an SRAM of a System-on-a-Chip (SoC), the SRAM having a plurality of arrays, one or more tests to determine one or more biased cells in the array, generate bias characteristics for each array of the SRAM based on the one or more biased cells of the array, compare bias characteristics of each of the plurality of arrays, select, based on the comparison, an array of the plurality of arrays as a Physically Unclonable Function (PUF) array, and store an identifier of the PUF array into a memory of the SoC.

### RELATED APPLICATION

This application claims the benefit of U.S. Provisional Application No. 63/369,598, filed Jul. 27, 2022, the entire contents of which are incorporated herein by reference.

### TECHNICAL FIELD

This disclosure generally relates to static random-access memory (SRAM), and more particularly, to generating keys based on entropy harvesting from embedded SRAM arrays.

### BACKGROUND

Many computing devices incorporate SRAM for storing executable code and data while the system is in operation. Further, many computing systems incorporate content protection, authorization functions, and/or device attestation functions that utilize keys. For example, content flowing to or from a computing device may be encrypted using data encryption and decryption hardware and software. This encryption protects secure data, which is potentially sensitive, private, and/or rights-managed and is stored or used on the system, from unauthorized access and exploitation.

Examples of computing systems that incorporate SRAM include artificial reality systems. In general, artificial reality is a form of reality that has been adjusted in some manner before presentation to a user, which may include, e.g., a virtual reality, an augmented reality, a mixed reality, a hybrid reality, or some combination and/or derivatives thereof. Artificial reality systems include one or more devices for rendering and displaying content to users. Examples of artificial reality systems may incorporate a head-mounted display (HMD) worn by a user and configured to output artificial reality content to the user. In some examples, the HMD may be coupled (e.g., wirelessly or in tethered fashion) to a peripheral device that performs one or more artificial reality-related functions.

### SUMMARY

In general, this disclosure is directed to techniques for generating keys based on entropy harvested from SRAM. A System-on-a-Chip (SoC) may have systems and subsystems that incorporate SRAM. The SRAM may be made up of multiple SRAM arrays, where each array can be composed of cells that store bit values. Due to variations in manufacturing processes and materials, a cell may be balanced, or it may exhibit bias towards a value of zero or one. For example, a balanced cell may have a value of zero (0) or one (1) with relatively equal probability when power is initially applied to the SRAM and before the cell is written. Alternatively, an unbalanced (e.g., biased) cell may have an inherent bias towards a value of 0 or 1 when power is initially applied to SRAM and before the cell is written. For example, a cell that takes a value of 1 sixty percent of the time when power is applied may be considered slightly biased towards 1, while a cell that takes a value of 1 ninety percent of the time when power is applied may be considered heavily biased towards one. Similarly, a cell that takes a value of 0 sixty-five percent of the time when power is applied may be considered slightly biased towards 0, while a cell that takes a value of 0 ninety-five percent of the time when power is applied may be considered heavily biased towards zero. A cell that frequently has the same value when power is applied to the SRAM may be referred to as a stable cell.

Techniques disclosed herein can analyze arrays of SRAM to determine arrays that have biased cell characteristics that make the sell suitable for a use as a Physically Unclonable Function (PUF). As an example, the techniques can be performed during testing of SoCs during or after an SoC manufacturing process, and can leverage SRAM testing methodologies that may be performed as part of the manufacturing process to determine SRAM arrays that have a suitable number of biased cells. The techniques can include determining, from the arrays that have biased cells, the array or arrays having bias characteristics that are most suitable for use as a PUF array. These techniques can be described as harvesting the entropy of the SRAM to determine a PUF array. The testing system can write an identifier of the PUF array to the SoC, for example, to a One-Time Programmable (OTP) Read-Only Memory (ROM) of the SoC. The SoC can then use the values of biased cells in the PUF array to determine a key for the SoC that can be used for encryption and decryption, device attestation, and/or other security purposes.

The entropy harvesting techniques used to identify a PUF array described in this disclosure provide several technical advantages. The techniques can utilize results of SRAM tests that may be performed during manufacturing of SoCs, thereby incurring little additional overhead during the manufacturing process. Additionally, existing systems to determine a PUF key typically require significant additional logic to be implemented on the SoC. The techniques disclosed herein have a technical advantage over such existing methodologies in that they do not require significant additional logic on the SoC.

In one example, this disclosure describes a method that includes for each array of a static random-access memory device (SRAM) of a System-on-a-Chip (SoC), the SRAM having a plurality of arrays, performing, by processing circuitry, one or more tests on the array and determining, based on the one or more tests, one or more biased cells in the array; generating, by the processing circuitry, bias characteristics for each array of the SRAM based on the one or more biased cells of the array; comparing, by the processing circuitry, bias characteristics of each of the plurality of arrays; selecting, by the processing circuitry and based on the comparison, an array of the plurality of arrays as a Physically Unclonable Function (PUF) array; and storing, by the processing circuitry, an identifier of the PUF array into a memory of the SoC.

In another example, this disclosure describes a testing system that includes one or more processors; and a memory storing instructions that, when executed, cause the one or more processors to: perform, on each array of an SRAM of a System-on-a-Chip (SoC), the SRAM having a plurality of arrays, one or more tests to determine one or more biased cells in the array, generate bias characteristics for each array of the SRAM based on the one or more biased cells of the array, compare bias characteristics of each of the plurality of arrays, select, based on the comparison, an array of the plurality of arrays as a Physically Unclonable Function (PUF) array, and store an identifier of the PUF array into a memory of the SoC.

In another example, this disclosure describes a System-on-a-Chip (SoC) integrated circuit that includes a plurality of SRAM arrays; and a security controller configured to: obtain an identifier from OTP memory, the identifier corresponding to an array of the plurality of SRAM arrays selected as a PUF array from among the plurality of SRAM arrays; and generate a key based on bit values of the PUF array.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is an illustration depicting an example artificial reality system, in accordance with techniques disclosed herein.

FIG. 2A is an illustration depicting an example HMD that includes an SoC, in accordance with techniques described in this disclosure.

FIG. 2B is an illustration depicting another example HMD that includes an SoC, in accordance with techniques described in this disclosure.

FIG. 3 is a block diagram showing example implementations of an HMD and a peripheral device of the multi-device artificial reality system of FIG. 1 in accordance with techniques described in this disclosure.

FIG. 4 is a block diagram illustrating an example implementation of a distributed architecture for a multi-device artificial reality system in which one or more devices are implemented using one or more SoC integrated circuits within each device, in accordance with techniques described in this disclosure.

FIG. 5 is a block diagram illustrating an example SoC that may be integrated within the HMD of FIGS. 1, 2A and 2B in accordance with the techniques of the disclosure.

FIG. 6 is a block diagram illustrating an example test system that tests SRAM of an SoC and generates PUF information, in accordance with techniques of the disclosure.

FIG. 7 is a flowchart illustrating example operations of a method for generating PUF information, in accordance with one or more techniques of the disclosure.

### DETAILED DESCRIPTION

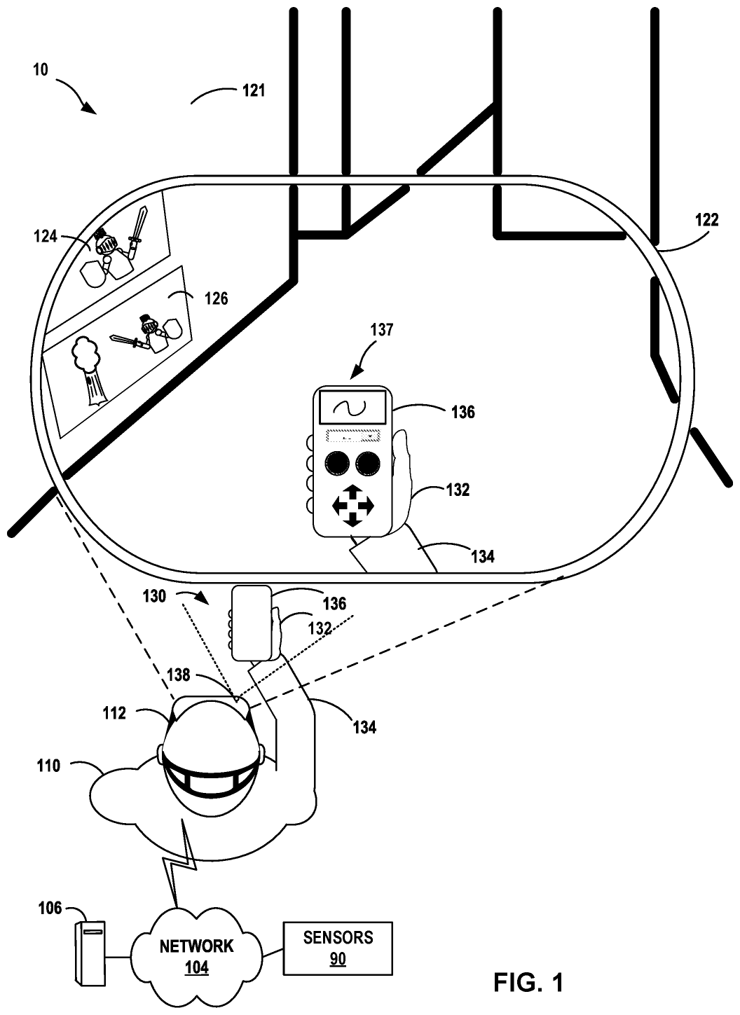

FIG. 1 is an illustration depicting an example artificial reality system, in accordance with techniques disclosed herein. In the example of FIG. 1, artificial reality system 10 includes HMD 112, peripheral device 136, and may in some examples include one or more external sensors 90 and/or console 106.

As shown in FIG. 1, HMD 112 is typically worn by user 110 and comprises an electronic display and optical assembly for presenting artificial reality content 122 to user 110. In addition, HMD 112 includes one or more sensors (e.g., accelerometers) for tracking motion of the HMD 112 and may include one or more image capture devices 138 (e.g., cameras, line scanners) for capturing image data of the surrounding physical environment. Although illustrated as a head-mounted display, AR system 10 may alternatively, or additionally, include glasses or other display devices for presenting artificial reality content 122 to user 110.

In this example, console 106 is shown as a single computing device, such as a gaming console, workstation, a desktop computer, or a laptop. In other examples, console 106 may be distributed across a plurality of computing devices, such as distributed computing network, a data center, or cloud computing system. Console 106, HMD 112, and sensors 90 may, as shown in this example, be communicatively coupled via network 104, which may be a wired or wireless network, such as Wi-Fi, a mesh network or a short-range wireless communication medium, or combination thereof. Although HMD 112 is shown in this example as in communication with, e.g., tethered to or in wireless communication with, console 106, in some implementations HMD 112 operates as a stand-alone, mobile artificial reality system.

In general, artificial reality system 10 uses information captured from a real-world, 3D physical environment to render artificial reality content 122 for display to user 110. In the example of FIG. 1, a user 110 views the artificial reality content 122 constructed and rendered by an artificial reality application executing on HMD 112 and/or console 106. In some examples, artificial reality content 122 may comprise a mixture of real-world imagery (e.g., hand 132, peripheral device 136, walls 121) and virtual objects (e.g., virtual content items 124, 126 and virtual user interface 137) to produce mixed reality and/or augmented reality. In some examples, virtual content items 124, 126 may be mapped (e.g., pinned, locked, placed) to a particular position within artificial reality content 122. A position for a virtual content item may be fixed, as relative to one of wall 121 or the earth, for instance. A position for a virtual content item may be variable, as relative to peripheral device 136 or a user, for instance. In some examples, the particular position of a virtual content item within artificial reality content 122 is associated with a position within the real-world, physical environment (e.g., on a surface of a physical object).

In this example, peripheral device 136 is a physical, real-world device having a surface on which AR system 10 overlays virtual user interface 137. Peripheral device 136 may include one or more presence-sensitive surfaces for detecting user inputs by detecting a presence of one or more objects (e.g., fingers, stylus) touching or hovering over locations of the presence-sensitive surface. In some examples, peripheral device 136 may include an output display, which may be a presence-sensitive display. In some examples, peripheral device 136 may be a smartphone, tablet computer, personal data assistant (PDA), or other hand-held device. In some examples, peripheral device 136 may be a smartwatch, smartring, or other wearable device. Peripheral device 136 may also be part of a kiosk or other stationary or mobile system. Peripheral device 136 may or may not include a display device for outputting content to a screen.

In the example artificial reality experience shown in FIG. 1, virtual content items 124, 126 are mapped to positions on wall 121. The example in FIG. 1 also shows that virtual content item 124 partially appears on wall 121 only within artificial reality content 122, illustrating that this virtual content does not exist in the real world, physical environment. Virtual user interface 137 is mapped to a surface of peripheral device 136. As a result, AR system 10 renders, at a user interface position that is locked relative to a position of peripheral device 136 in the artificial reality environment, virtual user interface 137 for display at HMD 112 as part of artificial reality content 122. FIG. 1 shows that virtual user interface 137 appears on peripheral device 136 only within artificial reality content 122, illustrating that this virtual content does not exist in the real-world, physical environment.

The artificial reality system 10 may render one or more virtual content items in response to a determination that at least a portion of the location of virtual content items is in the field of view 130 of user 110. For example, artificial reality system 10 may render a virtual user interface 137 on peripheral device 136 only if peripheral device 136 is within field of view 130 of user 110.

During operation, the artificial reality application constructs artificial reality content 122 for display to user 110 by tracking and computing pose information for a frame of reference, typically a viewing perspective of HMD 112. Using HMD 112 as a frame of reference, and based on a current field of view 130 as determined by a current estimated pose of HMD 112, the artificial reality application renders 3D artificial reality content which, in some examples, may be overlaid, at least in part, upon the real-world, 3D physical environment of user 110. During this process, the artificial reality application uses sensed data received from HMD 112, such as movement information and user commands, and, in some examples, data from any external sensors 90, such as external cameras, to capture 3D information within the real world, physical environment, such as motion by user 110 and/or feature tracking information with respect to user 110. Based on the sensed data, the artificial reality application determines a current pose for the frame of reference of HMD 112 and, in accordance with the current pose, renders the artificial reality content 122.

Artificial reality system 10 may trigger generation and rendering of virtual content items based on a current field of view 130 of user 110, as may be determined by real-time gaze tracking of the user, or other conditions. More specifically, image capture devices 138 of HMD 112 capture image data representative of objects in the real-world, physical environment that are within a field of view 130 of image capture devices 138. Field of view 130 typically corresponds with the viewing perspective of HMD 112. In some examples, the artificial reality application presents artificial reality content 122 comprising mixed reality and/or augmented reality. As illustrated in FIG. 1, the artificial reality application may render images of real-world objects, such as the portions of peripheral device 136, hand 132, and/or arm 134 of user 110, that are within field of view 130 along the virtual objects, such as within artificial reality content 122. In other examples, the artificial reality application may render virtual representations of the portions of peripheral device 136, hand 132, and/or arm 134 of user 110 that are within field of view 130 (e.g., render real-world objects as virtual objects) within artificial reality content 122. In either example, user 110 is able to view the portions of their hand 132, arm 134, peripheral device 136 and/or any other real-world objects that are within field of view 130 within artificial reality content 122. In other examples, the artificial reality application might not render representations of the hand 132 or arm 134 of the user.

During operation, artificial reality system 10 performs object recognition within image data captured by image capture devices 138 of HMD 112 to identify peripheral device 136, hand 132, including optionally identifying individual fingers or the thumb, and/or all or portions of arm 134 of user 110. Further, artificial reality system 10 tracks the position, orientation, and configuration of peripheral device 136, hand 132 (optionally including particular digits of the hand), and/or portions of arm 134 over a sliding window of time. In some examples, peripheral device 136 includes one or more sensors (e.g., accelerometers) for tracking motion or orientation of the peripheral device 136.

As described above, multiple devices of artificial reality system 10 may work in conjunction in the AR environment, where each device may be a separate physical electronic device and/or separate integrated circuits (e.g., one or more SoCs) within one or more physical devices. In this example, peripheral device 136 is operationally paired with HMD 112 to jointly operate within AR system 10 to provide an artificial reality experience. For example, peripheral device 136 and HMD 112 may communicate with each other as co-processing devices. As one example, when a user performs a user interface gesture in the virtual environment at a location that corresponds to one of the virtual user interface elements of virtual user interface 137 overlaid on the peripheral device 136, the AR system 10 detects the user interface gesture and performs an action that is rendered to HMD 112.

In accordance with the techniques of this disclosure, an SoC of artificial reality system 10 generates a private key using a physically unclonable function. The SoC may use this private key to, for example, perform device attestation to confirm that devices are authorized for use within system 10. The SoC may use the private key to encrypt and decrypt data exchanged with external entities, such as peripheral 136, console 106, sensors 90, or other external devices. The SoC may use the private key generated as described herein to encrypt private or personally identifying information stored within system 10. Further, the SoC may use the private key to verify the authenticity of software updates for devices in system 10. Other uses of the private key, generated as described herein, are contemplated.

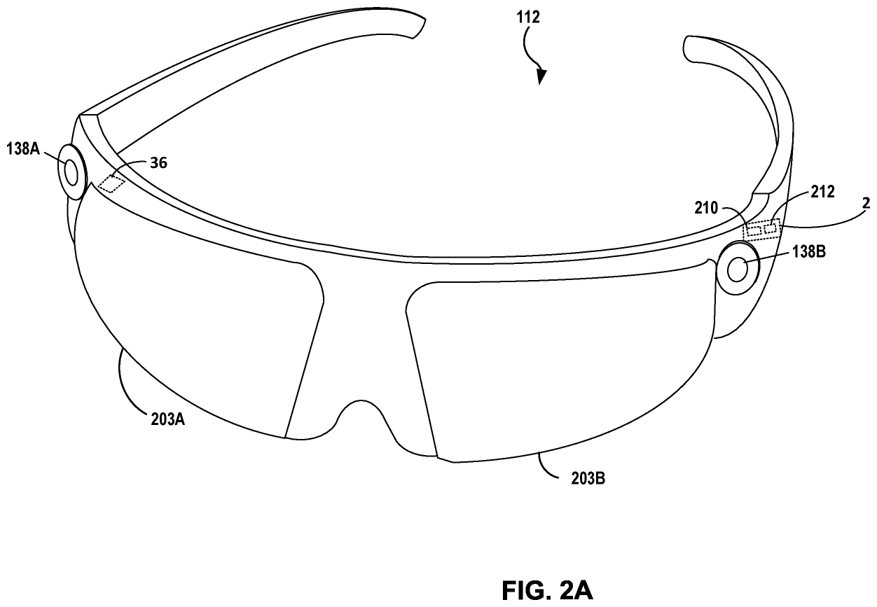

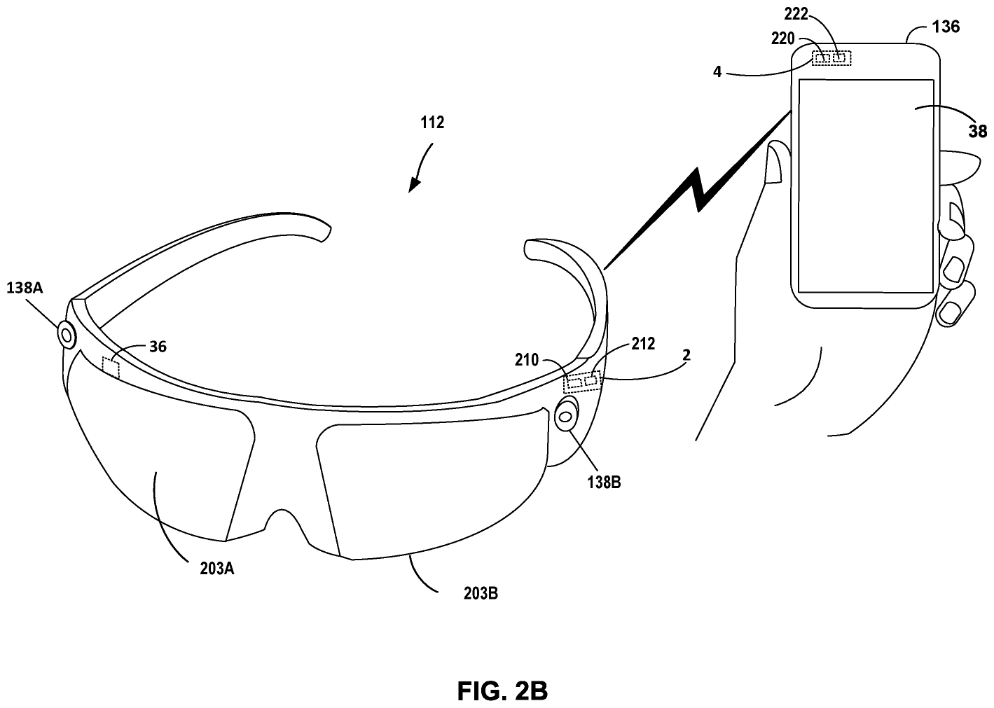

FIG. 2A is an illustration depicting an example HMD that includes an SoC, in accordance with techniques described in this disclosure. HMD 112 of FIG. 2A may be an example of HMD 112 of FIG. 1. HMD 112 may be part of an artificial reality system, such as artificial reality system 10 of FIG. 1, or may operate as a stand-alone, mobile artificial realty system configured to implement the techniques described herein. In the example of FIG. 2A, HMD 112 takes the general form factor of glasses.

In this example, HMD 112 includes a front rigid body and two stems to secure HMD 112 to a user, e.g., by resting over the wearer's ears. In the example of FIG. 2A, electronic display 203 may be split into multiple segments, such as into two segments, with each segment corresponding to a separate lens disposed on the rigid front body of HMD 112. In other examples in accordance with FIG. 2A, electronic displays 203A-203B (collectively, “electronic displays 203”) and may form a contiguous surface that spans both lenses and the lens-connecting bridge (i.e., the over-the-nose portion) of the rigid front body of HMD 112. In some examples in accordance with the form factor illustrated in FIG. 2A, electronic display 203 may also encompass portions of HMD 112 that connect the lenses of the front rigid body to the stems, or optionally, portions of the stems themselves. These various designs of electronic display 203 in the context of the form factor of HMD 112 shown in FIG. 2A improve accessibility for users having different visual capabilities (e.g., with respect to peripheral vision and/or central vision, nearfield vision and/or distance vision, etc.), eye movement idiosyncrasies, etc.

Electronic display 203 may be any suitable display technology, such as liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating visual output. In some examples, the electronic display is a stereoscopic display for providing separate images to each eye of the user. In some examples, the known orientation and position of display 203 relative to the front rigid body of HMD 112 is used as a frame of reference, also referred to as a local origin, when tracking the position and orientation of HMD 112 for rendering artificial reality content according to a current viewing perspective of HMD 112 and the user.

In the example illustrated in FIG. 2A, HMD 112 includes integrated image capture devices 138A and 138B (collectively, “image capture devices 138”). Image capture devices 138 may include still image camera hardware, video camera hardware, laser scanners, Doppler® radar scanners, fundus photography hardware, infrared imaging cameras, depth scanners, or the like. Image capture devices 138 may include outward-facing and/or inward-facing image capture hardware, and include any hardware configured to capture image data representative of a surrounding physical environment, and optionally, to preprocess and/or post process the captured image data. Outward-facing camera hardware of image capture devices 138 may capture image data of the physical environment outside of HMD 112, such as, but not limited to, the real-world environment at which a wearer of HMD 112 is positioned. Inward-facing camera hardware of image capture devices 138 may capture image data of the wearer of HMD 112, such as facial images and/or retina scans. Other inward-facing sensor hardware of HMD 112 may capture other types of information pertaining to the wearer, such as temperature information or other types of information or metrics.

In the example illustrated in FIG. 2A, HMD 112 further includes one or more motion sensors 36, such as one or more accelerometers (also referred to as inertial measurement units or “IMUs”) that output data indicative of current acceleration of HMD 112, GPS sensors that output data indicative of a location of HMD 112, radar, or sonar that output data indicative of distances of HMD 112 from various objects, or other sensors that provide indications of a location or orientation of HMD 112 or other objects within a physical environment.

In the example illustrated in FIG. 2A, HMD 112 includes HMD SoC 2. SoC 2 includes internal control unit 210, which may include an internal power source and one or more printed-circuit boards having one or more processors, memory, and hardware to provide an operating environment for executing programmable operations to process sensed data and present artificial reality content on display 203. SoC 2 of HMD 112 further includes security controller 212, which can use a private key generated using techniques further described below for device attestation, authentication, encryption/decryption, etc.

In one example, control unit 210 is configured to, based on the sensed data (e.g., image data captured by image capture devices 138, position information from GPS sensors), generate and render for display on display 203 a virtual surface comprising one or more virtual content items (e.g., virtual content items 124, 126 of FIG. 1) associated with a position contained within field of view of image capture devices 138. As explained with reference to FIG. 1, a virtual content item may be associated with a position within a virtual surface, which may be associated with a physical surface within a real-world environment, and control unit 210 can be configured to render the virtual content item (or portion thereof) for display on display 203 in response to a determination that the position associated with the virtual content (or portion therefore) is within the current field of view. In some examples, a virtual surface is associated with a position on a planar or other surface (e.g., a wall), and control unit 210 will generate and render the portions of any virtual content items contained within that virtual surface when those portions are within the field of view.

In one example, control unit 210 is configured to, based on the sensed data, identify a specific gesture or combination of gestures performed by the user and, in response, perform an action. For example, in response to one identified gesture, control unit 210 may generate and render a specific user interface for display on electronic display 203 at a user interface position locked relative to a position of the peripheral device 136. For example, control unit 210 can generate and render a user interface including one or more UI elements (e.g., virtual buttons) on surface 220 of peripheral device 136 or in proximity to peripheral device 136 (e.g., above, below, or adjacent to peripheral device 136). Control unit 210 may perform object recognition within image data captured by image capture devices 138 to identify peripheral device 136 and/or a hand 132, fingers, thumb, arm or another part of the user, and track movements, positions, configuration, etc., of the peripheral device 136 and/or identified part(s) of the user to identify pre-defined gestures performed by the user. In response to identifying a pre-defined gesture, control unit 210 takes some action, such as selecting an option from an option set associated with a user interface (e.g., selecting an option from a UI menu), translating the gesture into input (e.g., characters), launching an application, manipulating virtual content (e.g., moving, rotating a virtual content item), generating and rendering virtual markings, generating and rending a laser pointer, or otherwise displaying content, and the like. For example, control unit 210 can dynamically generate and present a user interface, such as a menu, in response to detecting a pre-defined gesture specified as a “trigger” for revealing a user interface (e.g., turning peripheral device to a landscape or horizontal orientation (not shown)). In some examples, control unit 210 detects user input, based on the sensed data, with respect to a rendered user interface (e.g., a tapping gesture performed on a virtual UI element). In some examples, control unit 210 performs such functions in response to direction from an external device, such as console 106, which may perform object recognition, motion tracking and gesture detection, or any part thereof.

As an example, control unit 210 can utilize image capture devices 138A and 138B to analyze configurations, positions, movements, and/or orientations of peripheral device 136, hand 132 and/or arm 134 to identify a user interface gesture, selection gesture, stamping gesture, translation gesture, rotation gesture, drawing gesture, pointing gesture, etc., that may be performed by users with respect to peripheral device 136. The control unit 210 can render a UI menu (including UI elements) and/or a virtual surface (including any virtual content items) and enable the user to interface with that UI menu and/or virtual surface based on detection of a user interface gesture, selection gesture, stamping gesture, translation gesture, rotation gesture, and drawing gesture performed by the user with respect to the peripheral device, as described in further detail below.

FIG. 2B is an illustration depicting another example HMD that includes an SoC, in accordance with techniques described in this disclosure. HMD 112 of FIG. 2B may be an example of HMD 112 of FIG. 1, and takes the form factor of glasses, as in the case of HMD 112 of FIG. 2A. In the example of FIG. 2B, image capture devices 138 may capture image data representative of various objects, including peripheral device 136 and/or of the hand(s) of user 110 in the physical environment that are within the FoV of image capture devices 138, which may generally correspond to the viewing perspective of HMD 112.

In the example illustrated in FIG. 2B, HMD 112 includes HMD SoC 2. SoC 2 includes internal control unit 210, which may include an internal power source and one or more printed-circuit boards having one or more processors, memory, and hardware to provide an operating environment for executing programmable operations to process sensed data and present artificial reality content on display 203. SoC 2 of HMD 112 further includes security controller 212, which can use a private key generated using techniques further described below for device attestation, authentication, encryption/decryption, etc.

Surface 38 of peripheral device 136 represents an input component or a combined input/output component of peripheral device 136. Surface 38 may include sensing capabilities, such as those of a touchscreen (e.g., a capacitive touchscreen, resistive touchscreen, surface acoustic wave (SAW) touchscreen, infrared touchscreen, optical imaging touchscreen, acoustic pulse recognition touchscreen, or any other touchscreen), touchpad, buttons, trackball, scroll wheel, or other presence-sensitive hardware that uses capacitive, conductive, resistive, acoustic, or other technology to detect touch and/or hover input.

Surface 38 may enable peripheral device 136 to receive touch input or gesture input without direct contact with surface 38. User 110 may provide these touch or gesture inputs to peripheral device 136 to provide instructions directly to peripheral device 136, or indirectly to HMD 112 and/or other components of an artificial reality system in which HMD 112 is deployed. In some examples, a processor of HMD 112 may utilize image capture devices 138 to analyze configurations, positions, movements, and/or orientations of peripheral device 136, of the hand(s) or digit(s) thereof of a user of peripheral device 136 to enable to provide input using gestures such as drawing gestures or typing gestures provided via a graphical keyboard.

Peripheral device 136 can communicate data to HMD 112 (and/or console 16) using wireless communications links (e.g., Wi-Fi™, near-field communication of short-range wireless communication such as Bluetooth®, etc.), or using wired communication links, or combinations thereof, or using other types of communication links. In the example of FIG. 2B, peripheral device 136 is also communicatively coupled to a network (e.g., network 104 of FIG. 1), thereby enabling peripheral device 136 to communicate data to remote devices over the network.

In this way, peripheral device 136 may offload various hardware and resource burdens from HMD 112, which enables low-profile form factor designs of HMD 112. Peripheral device 136 also serves as a communications intermediary between HMD 112 and devices at remote locations, via network 18. Further details of peripheral device 136 are described in U.S. patent application Ser. No. 16/506,618 (filed on 9 Jul. 2019), the entire content of which is incorporated herein by reference.

Peripheral device 136 may also include peripheral SoC 4. SoC 4 includes internal control unit 220, which may include an internal power source and one or more printed-circuit boards having one or more processors, memory, and hardware to provide an operating environment for executing programmable operations to process sensed data and perform functions offloaded from HMD 112. SoC 4 of peripheral device 136 further includes security controller 222, which can use a private key generated using techniques further described below for device attestation, authentication, encryption/decryption, etc.

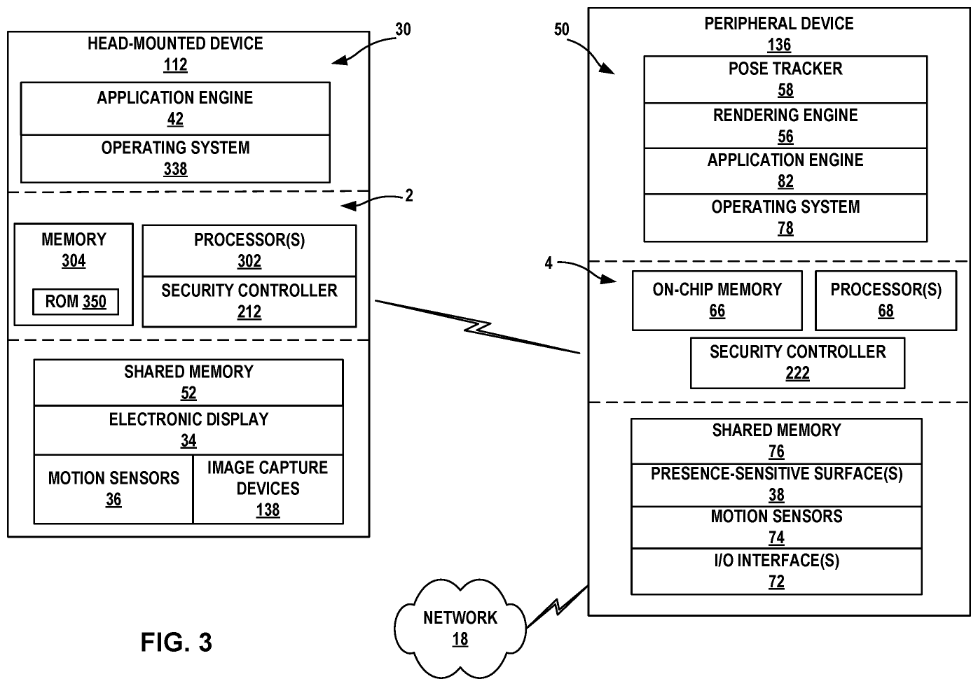

FIG. 3 is a block diagram showing example implementations of an HMD and a peripheral device of the multi-device artificial reality system of FIG. 1 in accordance with techniques described in this disclosure. In this example, HMD SoC 2 of HMD 112 includes one or more processors 302 and memory 52.

Shared memory 52 and processor(s) 302 of HMD 112 may, in some examples, provide a computer platform for executing an operating system 338. Operating system 338 may represent an embedded, real-time multitasking operating system, for instance, or other type of operating system. In turn, operating system 338 provides a multitasking operating environment for executing one or more software components 30, including application engine 42.

Processor(s) 302 may be coupled to one or more of electronic display 203, motion sensors 36, and/or image capture devices 138. Processor(s) 302 are included in HMD SoC 2, which also includes on-chip memory 304. On-chip memory 304 is collocated with processor(s) 302 within a single integrated circuit denoted as HMD SoC 2 in the particular example shown in FIG. 3. Processor(s) 302 may use on-chip memory 304 as a temporary storage location for self-contained data processing performed within HMD SoC 2. As shown in FIG. 3, HMD SoC 2 includes security controller 212, which can use a private key generated using techniques further described below for device attestation, authentication, encryption/decryption, etc.

HMD 112 is communicatively coupled to peripheral device 136, as shown in FIG. 3. In some examples, peripheral device 136 and HMD 112 function in tandem as co-processing devices to deliver the artificial reality experiences to user 110 as described above with respect to FIGS. 1, 2A, and 2B. Peripheral device 136 may offload portions of the computing tasks otherwise performed by HMD 112, thereby enabling a reduced hardware infrastructure and therefore a lower-profile form factor with respect to the design of HMD 112.

Peripheral device 136 includes presence-sensitive surface 38 (described above with respect to FIG. 2), as well as input/output (I/O) interface(s) 72, and motion sensors 74. Peripheral device 136 may invoke I/O interface(s) 72 to send and receive data over network 18, such as cipher text or plain text (unencrypted) data. I/O interface(s) 72 may also incorporate hardware that enables peripheral device 136 to communicate wirelessly with HMD 112. Peripheral device 136 may invoke motion sensors 74 to detect and track motion by the user of HMD 112 for use in computing updated pose information for a corresponding frame of reference of HMD 112.

Peripheral SoC 4 of peripheral device 136 includes on-chip memory 66 and one or more processors 68. On-chip memory 66 represents memory collocated with processor(s) 68 within a single integrated circuit denoted as peripheral SoC 4 in the particular example shown in FIG. 3. Processor(s) 68 may use on-chip memory 66 as a temporary storage location for self-contained data processing performed within peripheral SoC 4.

As shown in FIG. 3, peripheral SoC 4 of peripheral device 136 further includes security controller 222, which can use a private key generated using techniques further described below for device attestation, authentication, encryption/decryption, etc.

Shared memory 76 and processor(s) 68 of peripheral device 136 provide a computer platform for executing an operating system 78. Operating system 78 may represent an embedded, real-time multitasking operating system, for instance, or other type of operating system. In turn, operating system 78 provides a multitasking operating environment for executing one or more software components 50.

Apart from operating system 78, software components 50 include an application engine 82, a rendering engine 56, and a pose tracker 58. In some examples, software components 50 may not include rendering engine 56, and HMD 112 may perform the rendering functionalities without co-processing with peripheral device 136. In general, application engine 82, when invoked, provides functionality to provide and present an artificial reality application, e.g., a teleconference application, a gaming application, a navigation application, an educational application, a training application, a simulation application, or the like, to user 110 via HMD 112. Application engine 82 may include, for example, one or more software packages, software libraries, hardware drivers, and/or Application Program Interfaces (APIs) for implementing an artificial reality application. Responsive to control by application engine 82, rendering engine 56 generates artificial reality content 122 (e.g., incorporating 3D artificial reality content) for display to user 110 by application engine 42 of HMD 112.

Application engine 82 and rendering engine 56 construct artificial reality content 122 for display to user 110 in accordance with current pose information for a frame of reference, typically a viewing perspective of HMD 112, as determined by pose tracker 58. Based on the current viewing perspective as determined by pose tracker 58, rendering engine 56 constructs artificial reality content 122 (e.g., 3D artificial content) which may in some cases be overlaid, at least in part, upon the real-world 3D environment of user 110.

During this process, pose tracker 58 operates on sensed data received from HMD 112, such as movement information and user commands, and, in some examples, data from any external sensors 26 (shown in FIG. 1), to capture 3D information within the real-world environment, such as motion by user 110 and/or feature tracking information with respect to user 110. Based on the sensed data, pose tracker 58 determines a current pose for the frame of reference of HMD 112 and, in accordance with the current pose, constructs artificial reality content 122 for communication, via one or more I/O interfaces 72, to HMD 112 for display to user 110.

Each of processors 302 and 68 may comprise any one or more of a multi-core processor, a controller, a digital signal processor (DSP), an application specific integrated circuit (ASIC), a field-programmable gate array (FPGA), processing circuitry (e.g., fixed-function circuitry or programmable circuitry or any combination thereof) or equivalent discrete or integrated logic circuitry. Any one or more of shared memory 52, shared memory 76, on-chip memory 304, or on-chip memory 66 may comprise any form of memory for storing data and executable software instructions, such as random-access memory (RAM), Static RAM (SRAM), read only memory (ROM), programmable read only memory (PROM), erasable programmable read only memory (EPROM), electronically erasable programmable read only memory (EEPROM), or flash memory.

In some examples, memory 304 comprises ROM 350, which is a read-only memory. In some examples, ROM 350 stores instructions for executing operating system 305. In some examples, ROM 350 stores instructions for performing a boot-strapping operation at power-on of HMD 112 (or SoC 2) to initialize and execute operating system 305. ROM 350 typically stores a collection of various sub-routines, many of which have a pre-defined deterministic control flow. Other sub-routines stored by ROM 350 may be determined at run-time, such as one-time programming (OTP) write, servicing alarms or interrupts, execution of patches, etc.

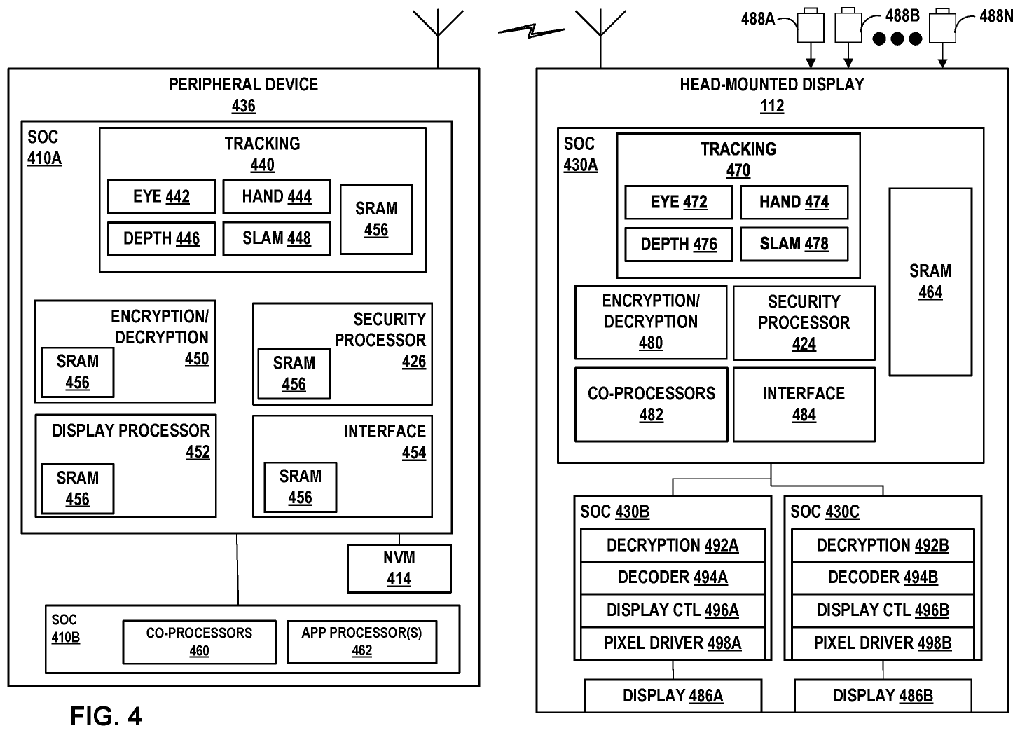

FIG. 4 is a block diagram illustrating an example implementation of a distributed architecture for a multi-device artificial reality system in which one or more devices are implemented using one or more systems-on-a-chip (SoCs) integrated circuits within each device and having wireless communication systems, in accordance with techniques described in this disclosure. FIG. 4 illustrates an example in which HMD 112 operates in conjunction with peripheral device 436. Peripheral device 436 represents a physical, real-world device having a surface on which multi-device artificial reality systems, such as systems 100, overlays virtual content. Peripheral device 436 may include an interface 454 having one or more presence-sensitive surface(s) for detecting user inputs by detecting a presence of one or more objects (e.g., fingers, stylus, etc.) touching or hovering over locations of presence-sensitive surfaces. In some examples, peripheral device 436 may have a form factor similar to any of a smartphone, a tablet computer, a personal digital assistant (PDA), or other hand-held device. In other examples, peripheral device 436 may have the form factor of a smartwatch, a so-called “smart ring,” or other wearable device. Peripheral device 436 may also be part of a kiosk or other stationary or mobile system. Interface 454 may incorporate output components, such as one or more display device(s), for outputting visual content to a screen. As described above, HMD 112 is architected and configured to enable the execution of artificial reality applications.

In this example, HMD 112 and peripheral device 436 include SoCs 430A, 410A, respectively, that represent a collection of specialized integrated circuits arranged in a distributed architecture and configured to provide an operating environment for artificial reality applications. As examples, SoC integrated circuits may include specialized functional blocks operating as co-application processors, sensor aggregators, encryption/decryption engines, security processors, hand/eye/depth tracking and pose computation elements, video encoding and rendering engines, display controllers and communication control components. Some or all of these functional blocks may be implemented as subsystems that include SRAM. FIG. 4 is merely one example arrangement of SoC integrated circuits. The distributed architecture for a multi-device artificial reality system may include any collection and/or arrangement of SoC integrated circuits.

In the example of FIG. 4, HMD 112 includes SoCs 430A, 430B and 430C in accordance with the techniques of the present disclosure. SoC 430A includes SRAM 464. SRAM 464 can be separated or external (e.g., not on-die) from the processor(s) and other on-die circuitry of SoC 430A. Peripheral device 436, in this example, is implemented using a traditional SoC architecture, in which SoC 410A includes an on-die SRAM 456 that may be distributed across subsystems of SoC 410A, and external (off-die) non-volatile local memory 414. In contrast, in accordance with the techniques of the present disclosure, SoC 430A does not include an external non-volatile local memory; instead, SRAM 464 has sufficient memory capacity to perform the functions of both traditional on-die SRAM (such as SRAM 456) and external non-volatile local memory (such as NVM 414).

Head-mounted displays, such as HMD 112 as used in AR/VR systems as described herein, can benefit from the reduction in size, increased processing speed and reduced power consumption provided by the SoC/SRAM 430. For example, the benefits provided by the SoC 430 in accordance with the techniques of the present disclosure can result in increased comfort for the wearer and a more fully immersive and realistic AR/VR experience.

In addition, it shall be understood that any of SoCs 410 and/or 430 may be implemented using an SoC/SRAM integrated circuit component in accordance with the techniques of the present disclosure, and that the disclosure is not limited in this respect. Any of the SoCs 410 and/or 430 may benefit from the reduced size, increased processing speed and reduced power consumption provided by SoC/SRAM integrated circuit described herein. In addition, the benefits provided by the SoC/SRAM component in accordance with the techniques of the present disclosure are not only advantageous for AR/VR systems, but may also be advantageous in many applications such as autonomous driving, edge-based artificial intelligence, Internet-of-Things, and other applications which require highly responsive, real-time decision-making capabilities based on analysis of data from a large number of sensor inputs.

In this example, SoC 430A of HMD 112 comprises functional blocks including security processor 424, tracking 470, an encryption/decryption 480, co-processors 482, and an interface 484. Tracking 470 provides a functional block for eye tracking 472 (“eye 472”), hand tracking 474 (“hand 474”), depth tracking 476 (“depth 476”), and/or Simultaneous Localization and Mapping (SLAM) 478 (“SLAM 478”). Some or all these functional blocks may be implemented within one or more subsystems of SoC 430A. As an example of the operation of these functional blocks, HMD 112 may receive input from one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. HMD 112 may also receive image data from one or more image capture devices 488A-488N (collectively, “image capture devices 488”). Image capture devices may include video cameras, laser scanners, Doppler radar scanners, depth scanners, or the like, configured to output image data representative of the physical environment. More specifically, image capture devices capture image data representative of objects (including peripheral device 436 and/or hand) in the physical environment that are within a field of view of image capture devices, which typically corresponds with the viewing perspective of HMD 112. Based on the sensed data and/or image data, tracking 470 determines, for example, a current pose for the frame of reference of HMD 112 and, in accordance with the current pose, renders the artificial reality content.

Encryption/decryption 480 of SoC 430A is a functional block of circuitry to encrypt outgoing data communicated to peripheral device 436 or a security server and decrypt incoming data communicated from peripheral device 436 or a security server. Coprocessors 482 include one or more processors for executing instructions, such as a video processing unit, graphics processing unit, digital signal processors, encoders and/or decoders, AR/VR applications and/or others.

Interface 484 of SoC 430A is a functional block of circuitry that includes one or more interfaces for connecting to functional blocks of SoC 430B and/or 430C. As one example, interface 484 may include peripheral component interconnect express (PCIe) slots. SoC 430A may connect with SoC 430B, 430C using interface 484. SoC 430A may connect with a communication device (e.g., radio transmitter) using interface 484 for communicating with other devices, e.g., peripheral device 436.

SoCs 430B and 430C of HMD 112 each represents display controllers for outputting artificial reality content on respective displays, e.g., displays 486A, 486B (collectively, “displays 486”). In this example, SoC 430B may include a display controller for display 486A to output artificial reality content for a left eye 487A of a user. For example, SoC 430B includes a decryption block 492A, decoder block 494A, display controller 496A, and/or a pixel driver 498A for outputting artificial reality content on display 486A. Similarly, SoC 430C may include a display controller for display 486B to output artificial reality content for a right eye 487B of the user. For example, SoC 430C includes decryption 492B, decoder 494B, display controller 496B, and/or a pixel driver 498B for generating and outputting artificial reality content on display 486B. Displays 468 may include Light-Emitting Diode (LED) displays, Organic LEDs (OLEDs), Quantum dot LEDs (QLEDs), Electronic paper (E-ink) displays, Liquid Crystal Displays (LCDs), or other types of displays for displaying AR content.

In this example, peripheral device 436 includes SoCs 410A and 410B configured to support an artificial reality application. In this example, SoC 410A comprises functional blocks including security processor 226, tracking 440, an encryption/decryption 450, a display processor 452, and an interface 454. Tracking 440 is a functional block of circuitry providing eye tracking 442 (“eye 442”), hand tracking 444 (“hand 444”), depth tracking 446 (“depth 446”), and/or Simultaneous Localization and Mapping (SLAM) 448 (“SLAM 448”). Some or all of these functional blocks may be implemented in various subsystems of SoC 410A. As an example of the operation of SoC 410A, peripheral device 436 may receive input from one or more accelerometers (also referred to as inertial measurement units or “IMUs”) that output data indicative of current acceleration of peripheral device 436, GPS sensors that output data indicative of a location of peripheral device 436, radar or sonar that output data indicative of distances of peripheral device 436 from various objects, or other sensors that provide indications of a location or orientation of peripheral device 436 or other objects within a physical environment. Peripheral device 436 may in some examples also receive image data from one or more image capture devices, such as video cameras, laser scanners, Doppler radar scanners, depth scanners, or the like, configured to output image data representative of the physical environment. Based on the sensed data and/or image data, tracking block 440 determines, for example, a current pose for the frame of reference of peripheral device 436 and, in accordance with the current pose, renders the artificial reality content to HMD 112.

Encryption/decryption 450 of SoC 410A encrypts outgoing data communicated to HMD 112 or security server and decrypts incoming data communicated from HMD 112 or security server. Encryption/decryption 450 may support symmetric key cryptography to encrypt/decrypt data using a session key (e.g., secret symmetric key). Display processor 452 of SoC 410A includes one or more processors such as a video processing unit, graphics processing unit, encoders and/or decoders, and/or others, for rendering artificial reality content to HMD 112. Interface 454 of SoC 410A includes one or more interfaces for connecting to functional blocks of SoC 410A. As one example, interface 484 may include peripheral component interconnect express (PCIe) slots. SoC 410A may connect with SoC 410B using interface 484. SoC 410A may connect with one or more communication devices (e.g., radio transmitter) using interface 484 for communicating with other devices, e.g., HMD 112.

SoC 410B of peripheral device 436 includes co-application processors 460 and application processors 462. In this example, co-processors 460 include various processors, such as a vision processing unit (VPU), a graphics processing unit (GPU), and/or central processing unit (CPU). Application processors 462 may execute one or more artificial reality applications to, for instance, generate and render artificial reality content and/or to detect and interpret gestures performed by a user with respect to peripheral device 436.

Security processor 424 of SoC 410A and/or security processor 426 of SoC 430A may generate and use a private key according to techniques further described below. Security processor 424 and/or security processor 426 may use such a key for device attestation, authentication, encryption/decryption, etc. Encryption/decryption 450 and/or encryption/decryption 480 may also use such a key. Although not shown in FIG. 4, other SoCs such as SoCs 410B, 430B and 430C may also include a security processor similar to security processor 424 and 426.

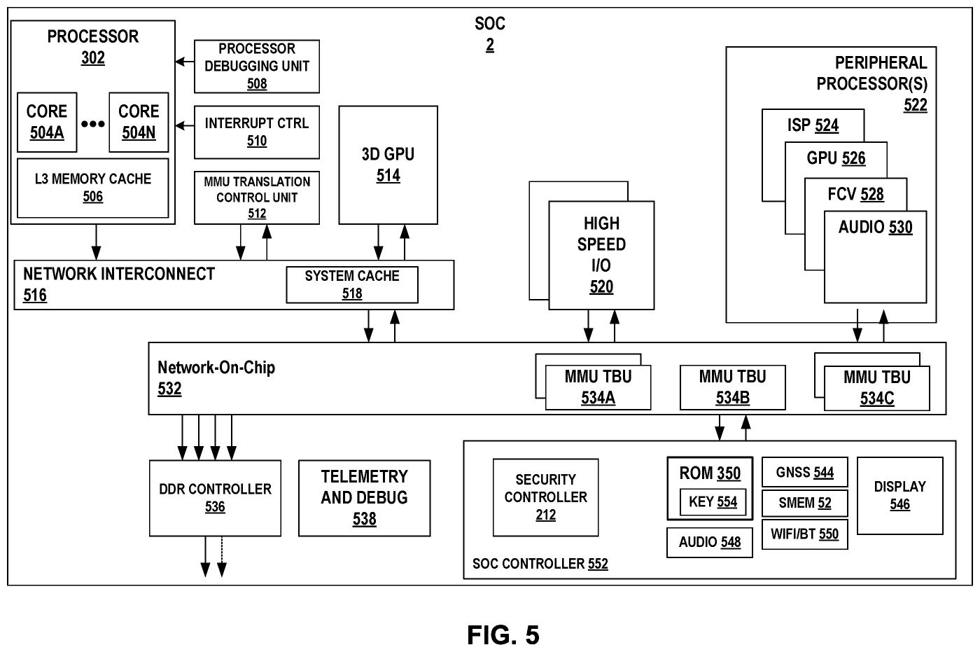

FIG. 5 is a block diagram illustrating an example SoC that may be integrated within the HMD of FIGS. 1, 2A and 2B in accordance with the techniques of the disclosure. In some aspects, SoC 2 includes processor 302, 3D GPU 514, high-speed I/O 520, peripheral processors 522, Network-on-Chip (NoC) integrated circuit 532, DDR controller 536, and controller 552.

Processor 302 is one or more microprocessors, digital signal processors (DSPs), application specific integrated circuits (ASICs), field programmable gate arrays (FPGAs), or any other equivalent integrated or discrete logic circuitry, as well as any combinations of such components. Processor 302 comprises a plurality of processing cores 504A-504N (collectively, “cores 504”). Processor 302 further comprises L3 memory cache 506. L3 memory cache 506 comprises a common memory cache shared by cores 504. Processor debugging unit 508 provides debugging capabilities for processor 302. Interrupt controller 510 services interrupts generated by processor 302 and/or SoC 2.

3D graphic processing unit (GPU) 514 is a graphics process unit that may be configured to provide 3-dimensional (3D) graphics processing capabilities. In some examples, 3D GPU 514 comprises a plurality of cores or cells configured to provide parallel processing capabilities for rendering 3D images or video.

High-speed I/O 520 may provide high-speed input and output capabilities to SoC for communicating with components exterior to SoC 2, such as with other components of HMD 112 or peripheral device 136.

Peripheral processors 522 provide dedicated processors for different types of data serviced by SoC 2. Peripheral processors 522 may include integrated circuitry or hardware configured to process specific types of data. For example, peripheral processors 522 may include image signal processor (ISP) 524 for processing images, GPU 526, FCV 528, and audio processing unit 530.

Network interconnect 516 provides a high-speed interconnection medium between various components of SoC 2, particularly to data transferred between processor 302, 3D GPU 514, memory management unit (MMU) translation control unit (TCU) 512, and MMU translation buffer units (TBUs) 534A-534C of NoC integrated circuit 532, high-speed I/O 520, peripheral processors 522, and DDR controller 536. Network interconnect 516 may include a system cache 518 for storing and/or buffering data transferred between various components of SoC 2.

SoC 2 further includes telemetry and debug unit 538. Telemetry and debug unit 538 may record and transmit telemetry for SoC 2 to an external device, such as HMD 112 or peripheral device 136. Further, telemetry and debug unit 538 may provide debugging functionalities for SoC 2.

SoC controller 552 provides various controllers for driving various functionality of SoC 2. For example, SoC controller 552 includes security controller 212, ROM 350, shared memory 52, audio controller 548, GNSS 544, WIFI and Bluetooth® controller 550, and display controller 546.

Security controller 212 of SoC 2 uses techniques described herein to generate key 554. Key 554 may be generated using a physically unclonable function that is determined as will be further described below. Security controller 212 may use key 554 to perform device attestation to confirm that devices are authorized for use by SoC 2. SoC 2 may use key 554 to encrypt and decrypt data exchanged with external entities. SoC 2 may use key 554 to encrypt private or personally identifying information stored or used by SoC 2. Further, SoC 2 may use key 554 to verify the authenticity of software updates for SoC 2 or its components. SoC 2 may use key 554, generated as described herein, for other purposes in some cases.

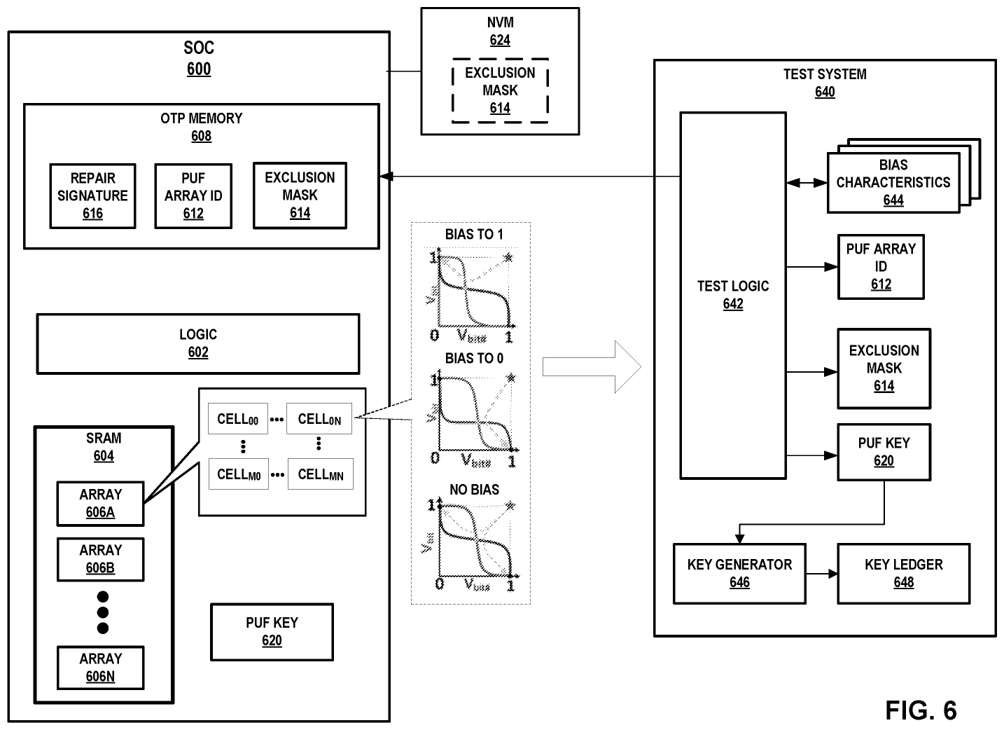

FIG. 6 is a block diagram illustrating an example test system that tests SRAM of an SoC and generates PUF information, in accordance with techniques of the disclosure. In the example illustrated in FIG. 6, test system 640 includes test logic 642 that tests SoCs such as SoC 600. Test system 640 may be incorporated as part of a production process of SoCs at an SoC manufacturing facility, or it may be part of a testing facility that tests SoCs received from a manufacturing facility (e.g., a third-party manufacturing facility).

SoC 600 can be an implementation of any of SoCs 410A and 410B of peripheral device 436, and SoCs 430A-C of HMD 112 described in FIG. 4. As another example, SoC 600 may be an implementation of SoC 2 of FIG. 5. SoC 600 can include logic 602, SRAM 604 and OTP memory 608.

Logic 602 can include processing circuitry that implements processing logic performed by SoC 600. For example, logic 602 may implement the functionality provided by HMD 112 and/or peripheral device 136 of FIGS. 1, 3 and 4.

SRAM 604 can include arrays 606A-606N (collectively, “arrays 606”) of bit cells. The cells each include circuitry that implements a bit of SRAM 604. In some aspects, an array of cells can be an M×N array of cells, where each row in the array is a memory location of SRAM 604 and each column of the array is a bit at the memory location.

Test system 640 may test SoCs after the SoC have been manufactured and prior to shipment to customers. Test logic 642 of test system 640 may implement testing algorithms to test various functions and components of SoC 600. For example, test logic 642 may include tests designed to test the reliability of SRAM 600. For example, test logic 642 may implement a read-write margin test. The read-write margin test includes measuring the margin between the voltage required for a successful write to the cell and a noise voltage. In some aspects, the read-write margin test determines the voltage required to write a 0 to the cell and the voltage required to write a 1 to the cell. If the voltages are the same, the cell is not biased to either a value of 0 or 1. If one of the voltages is less than the other, the cell is biased to the value that requires less voltage to write. For example, if the voltage to write a 1 to a cell is less than the voltage required to write a 0 to the cell, the cell is biased to a value of 1.

Additionally, or instead, test logic 642 may implement a leakage test. In some implementations of a leakage test, test logic 642 writes a 1 to a cell and measures the leakage power after the write. Test logic 642 also writes a 0 to the cell and measures the leakage power after the write. If the leakage powers are the same, the cell is not biased to either a value of 0 or 1. If the leakage powers are different, the cell is biased to the value with the lesser leakage power. In some implementations of the leakage test, test logic 642 performs leakage measurement by progressively increasing the number of is in an array to reveal the bias towards 1 or 0.

It may be the case that it is impractical to measure the leakage power of individual cells of an SRAM array, as the power values may be too small to be reliably measured at the cell level. In some aspects, test logic 642 implements a combined leakage and read-write test. In a first pass, test logic 642 selects a group of cells for test, and writes a 1 to each cell in the group of cells, and measures the leakage power for the group as a whole. Similarly, test logic 642 writes a 0 to each cell of the group of cells and measures the leakage power for the group as a whole. If the leakage power is the same for both values, none of the cells in the group are biased to either a 0 or a 1. If the leakage power is different for the group, then at least one of the cells is biased to a 0 or 1. Test logic 642 can perform the read-write margin on the cells in the group to determine which cells in the group are biased, and the value (0 or 1) to which the biased cells are biased.

In addition to, or instead of, the read-write margin test and the leakage test, test logic 642 may perform a temporal aggregation test and/or a spatial aggregation test to determine whether cells in an SRAM array are biased to a value of 0 or 1. In the temporal aggregation test, the test logic 642 can iteratively apply power to “wake up” the SRAM array and read the bit values from the array after power has been applied (and before any values have been specifically written to the array). If a cell frequently takes on the same value after each iteration, the test logic 642 can mark the cell as biased to the value. For example, assume that test logic 642 performs 100 iterations of the temporal aggregation test. If, after wake-up, a cell has a value of 0 for 85 of the iterations, test logic 642 can mark the cell as being biased to 0. If, after the 100 iterations, the cell exhibits random behavior, e.g., a roughly equal number of 0s and 1s, then test logic 642 can mark the cell as being unbiased. The number or proportion of iterations resulting in a same value needed to determine that a cell is biased may be higher or lower than 85 and may be configurable by an operator of test system 640. In some aspects, the system operates the SRAM at full voltage supply and retention voltage supply during the temporal aggregation tests.

In the spatial aggregation test, test logic 642 can aggregate cells into groups of cells. Test logic 642 can then iteratively apply power to wake up the SRAM array. After each iteration, test logic 642 can count the number of cells in the group having a value of 0 and the number of cell in the group having a value of 1. If the count is roughly equal, test logic 642 can mark the group of cells is as being unbiased. If the count of cells in the group having a value of 0 is different from the count of cells in the group having a value of 1, test logic 642 can mark the group of cells as being biased. Again, assume test logic 642 performs 100 iterations of the spatial aggregation test and that each group has twenty cells. If, after the 100 iterations have been completed the average count of cells in the group having a value of 1 is sixteen and the average count of cells having a value of 0 is four, then test logic 642 can mark the group as being biased to the value of 1.

The number of iterations for the spatial aggregation test and the temporal aggregation test may be higher or lower than 100. Generally speaking, the number of iterations can be selected so as to provide a reasonable assurance that the bias in the cells or groups of cells is accurately detected.

In some aspects, test logic 642 may vary operating conditions of the SRAM between iterations. For example, test logic 642 may vary voltages or frequencies used during the iterations of the test.

Test logic 642 can determine bias characteristics for each of arrays 606. In some aspects, a bias characteristic can include the number of biased cells in any of arrays 606. In some aspects, the bias characteristics can include a count of the cells in any of arrays 606 that are biased to 0 and a count of the cells that are biased to 1.

After determining the bias characteristics for the arrays 606 of SRAM 604, test logic 642 can select an array for use as a PUF array. In some aspects, test logic 642 can select the array having the most biased cells as the PUF array. As an example, arrays 606 may have 1024 bits. Assume that array 606A has 305 biased cells while array 606B has 900 biased cells. In this example, test logic 642 may select array 606B as the PUF array. In some aspects, test logic 642 can select an array having a desirable balance between the number of cells biased to 1 and the number of cells biased to 0. In As an example, test logic 642 can determine a subset of arrays of SRAM 504 having a count of biased cells over a predetermined or configurable threshold. From this subset, test logic 642 can select the array having the best balance between cells biased to 0 and cells biased to 1 as the PUF array. Test logic 642 can use other mechanisms to select any of arrays 606 from SRAM 604 as a PUF array based on a desirable combination of number of biased cells and balance between values of biased cells.

After selecting which of arrays 606 to use as the PUF array, test logic 642 can store an identifier of the array selected as the PUF array to a memory of SoC 600. In some aspects, test logic 642 stores the identifier of the PUF array in PUF array ID 612 of OTP memory 608. In some aspects, test logic 642 can store the identifier of the PUF array in repair signature 616.

In some aspects, various techniques may be used to increase the stability of a PUF key generated from the PUF array. For example, in some aspects, directed high-voltage quick kill and long term aging may be used to reinforce favorable bias in SRAM to improve reliability. In high voltage quick kill, the manufacturing system conditions the SRAM arrays to high voltage and high temperature for a short time. Prior to doing such conditioning, the SRAM is woken to read out the native wake-up values, and write the complementary values back into them. This can ensure that the transistors in each SRAM bit-cell will degrade such that the existing bias is reinforced and PUF key stability improves. The same strategy can be applied in production parts where after derivation of the PUF in the boot sequence, the opposite (complementary) values are stored back in the biased SRAM, until the PUF key is derived again.

In some aspects, when SoC 600 boots, security controller 212 (FIG. 5) can restrict access to the PUF array from general use. As an example, security controller 212 may implement a memory firewall the blocks applications or other components of SoC 600 from using the memory of the PUF array identified by PUF array ID 612. In some aspects, security controller 212 can indicate, via the repair signature, that cells of the PUF array require repair, thereby causing the memory subsystem to substitute repair bits for the bits of the PUF array. When applications or other components of SoC 600 attempt to access the PUF array, they access the repair bits, while security controller 212 can access to original bits of the PUF array.

SoC 600 can utilize the PUF array to generate PUF key 620. For example, in some aspects, security controller 212 generates PUF key 620 based on the bit values of the PUF array. In some aspects, PUF key 620 may be key 554 of FIG. 5. The robustness of PUF key 620 can depend on the values of the biased cells of the PUF array being balanced between. Thus, it can be desirable for test logic 642 to select an array having a balance of biased cells using the techniques described above.

In some aspects, test logic 642 can also generate PUF key 620 using the same key generation algorithm as SoC 600 to ensure that the same key value is generated from the PUF array. Test system 640 can include a key generator 646 that receives PUF key 620. PUF key 620 can be considered a private key, and key generator 646 can generate a public key corresponding to the private PUF key. Key generator 646 can store the public key in key ledger 648 in association with an identifier associated with SoC 600.

In some aspects SoC 600 can use PUF key 620 for encryption, decryption, device attestation, authorization, or any other security function using keys. As an example, SoC 600 may receive software updates that can be signed using the public key associated with SoC 600. SoC 600 can verify the signature using PUF key 620 to determine that the software update is authentic. SoC 600 can use PUF key 620 to confirm that devices such as peripheral device 136 are authentic and authorized for use within a system incorporated SoC 600. For example, a peripheral can provide the public key for SoC 600, which can confirm the correct public key has been provided, indicating that the peripheral is authorized for use with SoC 600.

In some aspects, SoC 600 can generate exclusion mask 614. Exclusion mask 614 can be a bit mask indicating which bits of the PUF array are biased. Test system 640 can store the exclusion mask to a memory associated with SoC 600. SoC 600 can use the exclusion mask to generate PUF key 620 such that only bit values of biased cells indicated by exclusion mask 614 are used to generate PUF key 620. Bit values of unbiased cells of the PUF array can be ignored when SoC 600 generates PUF key 620. In some aspects, test system 640 can store exclusion mask 614 in OTP memory 608. Because exclusion mask 614 does not reveal any information about the actual bit values used to generate PUF key 620, or even which array is the PUF array, test system 640 may store exclusion mask 514 in a non-volatile general-purpose memory 624 associated with SoC 600.

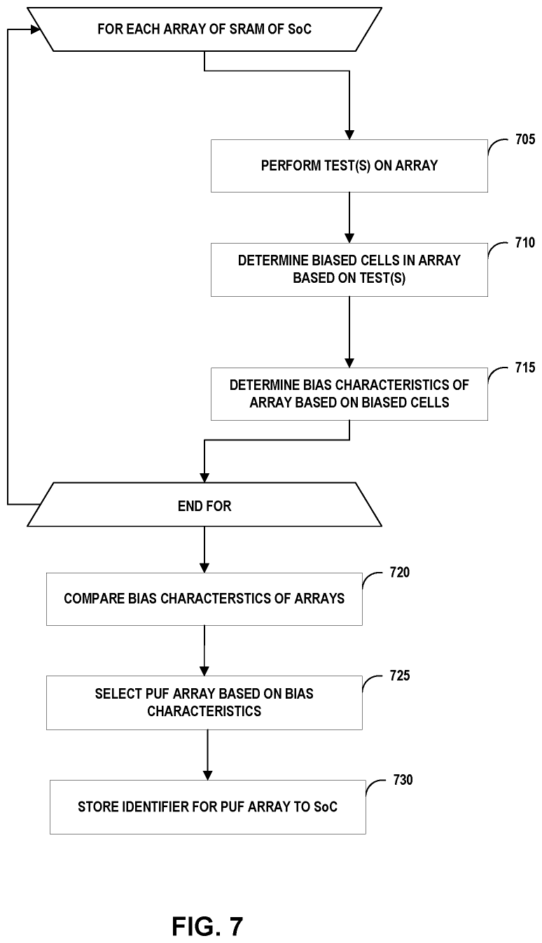

FIG. 7 is a flow diagram illustrating an example operation of a testing system, in accordance with one or more techniques of this disclosure. In some examples, a testing system may test arrays of an SRAM of an SoC. For each array of the SRAM, the testing system can perform one or more tests on the array (705) and determining, based on the one or more tests, one or more biased cells in the array (710). Next, a testing system may generate bias characteristics for each array of the SRAM based on the one or more biased cells of the array (715). Next, a testing system may compare bias characteristics of each of the plurality of arrays (720). Next, a testing system may select, based on the comparison, an array of the plurality of arrays as a Physically Unclonable Function (PUF) array (725). Next, the testing system may store, an identifier of the PUF array into a memory of the SoC (730). The SoC may use the PUF array in operation to generate a PUF key.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted device (HMD) connected to a host computer system, a standalone HMD, a mobile device or computing system, or any other hardware platform capable of providing artificial reality content to one or more viewers.

What is claimed is:

1. A method comprising:
for each array of a static random-access memory device (SRAM) of a System-on-a-Chip (SoC), the SRAM having a plurality of arrays, performing, by processing circuitry, one or more tests on the array and determining, based on the one or more tests, one or more biased cells in the array;
generating, by the processing circuitry, bias characteristics for each array of the SRAM based on the one or more biased cells of the array;
comparing, by the processing circuitry, bias characteristics of each of the plurality of arrays;
selecting, by the processing circuitry and based on the comparison, an array of the plurality of arrays as a Physically Unclonable Function (PUF) array; and
storing, by the processing circuitry, an identifier of the PUF array into a memory of the SoC.

2. The method of claim 1, wherein storing the identifier of the PUF array into the memory of the SoC comprises storing the identifier in One-Time Programmable memory.

3. The method of claim 1, wherein storing the identifier of the PUF array into the memory of the SoC comprises storing the identifier in a repair signature for the SRAM.

4. The method of claim 1, wherein performing the one or more tests comprises performing a read-write margin test.

5. The method of claim 1, wherein performing the one or more tests comprises performing a leakage test.

6. The method of claim 5, wherein performing the leakage test comprises performing the leakage test on a set of arrays of the plurality of arrays, wherein the method further comprises:
in response to determining that leakage test results indicate that at least one array of the set of arrays include a threshold number of unbalanced cells, performing a read-write margin test on the set of arrays, and determining the bias characteristics of the set of arrays based on the read-write margin test; and
in response to determining that leakage test results indicate that no array of the set of arrays include a threshold number of unbalanced cells, determining the bias characteristics of the at least one array based on the read-write margin test.

7. The method of claim 1, wherein the bias characteristics includes a number of biased cells, and wherein selecting the array of the plurality of arrays as the PUF array comprises selecting the array having the greatest number of biased cells.

8. The method of 1, wherein the bias characteristics includes a number of biased cells, and wherein selecting the array of the plurality of arrays as the PUF array comprises selecting the array having the greatest number of biased cells from a subset of arrays of the plurality arrays where a difference between a number of cells of the PUF array having a bias to zero and a number of cells of the PUF array having a bias to one is below a threshold value.

9. The method of claim 1, further comprising:
generating an exclusion mask for the PUF array, wherein a first bit value at a position in the exclusion mask indicates a corresponding cell in the PUF array is biased, and wherein a second bit value at the position in the exclusion mask indicates the corresponding cell in the PUF array is not biased.

10. The method of claim 1, wherein performing the one or more tests on the array comprises iteratively performing the one or more tests on the array, wherein determining the one or more biased cells in the array comprises determining a cell of the array is biased based on the cell having the same value for a threshold number of iterations of the one or more tests.

11. The method of claim 10, further comprising varying operating characteristics of the SRAM between iterations of the one or more tests.

12. The method of claim 1, wherein performing the one or more tests on the array comprises iteratively performing the one or more tests on the array, and wherein determining, based on the one or more tests, one or more biased cells in the array comprises:
creating a plurality of groups of cells of the array;
determining an aggregate value for each group of cells of the plurality of groups of cells during each iteration of the one or more tests; and
determining a group bias for each group of cells based on the aggregated value of the group, wherein a group of cells is biased towards a value if a threshold number of the cells have the value for a threshold number of iterations;
wherein determining the bias characteristics for the array comprises determining the bias characteristics based on the group biases of the groups of cells.

13. The method of claim 1, further comprising:
generating a private key based on the PUF array;
generating a public key based on the private key; and
storing the public key in a key ledger in association with an identifier of the SoC.

14. A testing system comprising:
one or more processors; and
a memory storing instructions that, when executed, cause the one or more processors to:
perform, on each array of a static random-access memory (SRAM) of a System-on-a-Chip (SoC), the SRAM having a plurality of arrays, one or more tests to determine one or more biased cells in the array,
generate bias characteristics for each array of the SRAM based on the one or more biased cells of the array,
compare bias characteristics of each of the plurality of arrays,
select, based on the comparison, an array of the plurality of arrays as a Physically Unclonable Function (PUF) array, and
store an identifier of the PUF array into a memory of the SoC.

15. The testing of claim 14, wherein to store the identifier of the PUF array into the memory of the SoC comprises to store the identifier in one of a One-Time-Programmable (OTP) memory or a repair signature for the SRAM.

16. The testing of claim 14, wherein to perform the one or more tests comprises to perform at least one of a read-write margin test or a leakage test.

17. The testing system of claim 14, wherein the bias characteristics includes a number of biased cells, and wherein the instructions to select the array of the plurality of arrays as the PUF array comprise instructions to select the array having the greatest number of biased cells.

18. The testing system of claim 14, wherein the instructions further comprise instructions to:
generate a private key based on the PUF array;
generate a public key based on the private key; and
store the public key in a key ledger in association with an identifier of the SoC.

19. A System-on-a-Chip (SoC) integrated circuit comprising:
a plurality of static random-access memory (SRAM) arrays; and
a security controller configured to:
obtain an identifier from OTP memory, the identifier corresponding to an array of the plurality of SRAM arrays selected as a PUF array from among the plurality of SRAM arrays; and
generate a key based on bit values of the PUF array.

20. The SoC of claim 19, wherein the security controller is further configured to:
obtain, from the OTP memory, an exclusion mask, wherein a first bit value at a position in the exclusion mask indicates a corresponding cell in the PUF array is biased, and wherein a second bit value at the position in the exclusion mask indicates the corresponding cell in the PUF array is not biased; and
generate the key based on the bit values of the PUF array that correspond to bits indicated in the exclusion mask to be biased.
